(19) United States
(12) Patent Application Publication
(10) Pub. No.: US 2013/0130032 A1
(43) Pub. Date: May 23, 2013

(54) FE-NI COMPOUND OXIDE FOR CHEMICAL LOOPING COMBUSTION PROCESS AND METHOD OF MANUFACTURING THE SAME

(71) Applicants: Yu-Lin KUO, Hsinchu (TW); Yu-Ming SU, Hsinchu (TW); Young KU, Hsinchu (TW); Yao-Hsuan TSENG, Hsinchu (TW); Ping-Chin CHIU, Hsinchu (TW); Chung-Sung TAN, Hsinchu (TW)

(72) Inventors: Yu-Lin KUO, Hsinchu (TW); Yu-Ming SU, Hsinchu (TW); Young KU, Hsinchu (TW); Yao-Hsuan TSENG, Hsinchu (TW); Ping-Chin CHIU, Hsinchu (TW); Chung-Sung TAN, Hsinchu (TW)

(73) Assignee: NATIONAL TSING HUA UNIVERSITY, Hsinchu (TW)

(21) Appl. No.: 13/466,340

(22) Filed: May 8, 2012

(30) Foreign Application Priority Data
Nov. 23, 2011 (TW) 1001142829

(51) Int. Cl. C01G 53/04; B32B 5/16; B82Y 30/00; B82Y 40/00

(52) U.S. Cl. 428/402; 423/594.1; 977/773; 977/896; 977/811

(57) ABSTRACT

A Fe—Ni compound oxide is used as an oxygen carrier for chemical looping combustion process, wherein the structure of the Fe—Ni compound oxide is a single-phase spinel structure. The method for manufacturing the Fe—Ni compound oxide of the invention includes the following steps: mixing Fe₂O₃ and NiO to obtain a mixing solution and ball milling the mixing solution by the solid state ball milling method; drying the mixing solution to obtain a precipitate; granulating the precipitate and then calcining the granulated precipitate to obtain the Fe—Ni compound oxide. Accordingly, the Fe—Ni compound oxide manufactured by the method of the invention is provided with high oxidation rate and high reduction rate, and capable of keeping loops and producing hydrogen gas.

### BACKGROUND OF THE INVENTION

1. Field of the Invention

The present invention relates to a Fe—Ni compound oxide for chemical looping combustion process and method of manufacturing the same, and more particularly to a Fe—Ni compound oxide which is used as an oxygen carrier for chemical looping combustion process and the structure of the Fe—Ni compound oxide is a single-phase spinel structure.

2. Description of the Prior Art

With the development and prosperity of scientific technology, many countries have begun to industrialize, however this has lead to environmental issues such as climate change, endangered species, energy, overpopulation, and industrial pollutions at the same time. In order to protect environmental quality, scientists and entrepreneurs have to strike the balance of environmental and economic. Therefore, the environmental impact of power generation plant and the development of green energy are our primary concern.

Thermal power is one of the most commonly used methods of power generation, wherein this method is generally classified into three categories based on the type of fuel, known as liquefied natural gas, petroleum and coal. By burning liquefied natural gas, petroleum or coal, the water can be heated and turned into steam, so that the power generator can produce enough power to be used as the main source of power. Comparing with other methods of power generation, thermal power brings about serious air pollution problems, and the major primary pollutants include sulphur oxides, nitrogen oxides, carbon monoxide, and carbon dioxide. Wherein, carbon dioxide is a colourless, odorless, and non-toxic greenhouse gas, and it is also the major reason of global warming and climate change. The emission of carbon dioxide can be reduced by sealing or reusing, but it would lead to a great consumption of energy due to the other pollutants in the exhaust gas emitted from thermal power plant should be segregated first.

in conventional methods, a chemical looping combustion process has been provided to improve the problem described above, wherein the process replaces air with metal oxygen carrier. The chemical looping combustion process generates heat source under oxidation-reduction reaction by two fluidized bed reactors (fuel reactor and air reactor). In other words, a reduction reaction proceeds in the fuel reactor, converting metal oxygen carrier into metal; after that, an oxidation reaction proceeds in the air reactor, the metal obtained above would be converted back to metal oxygen carrier; and then the reduction reaction and the oxidation reaction continue to proceed, repeating the process again and again. Wherein, the total reaction in the process is an exothermal reaction which can maintain the operation of system.

in conventional method, oxygen atoms are generated from air; but now with the chemical looping combustion process described previously, oxygen atoms can be generated from metal oxygen carrier, therefore, after condensing the gas emitted from burning fuel, the residual gas contains up to 99% carbon dioxide. Thus, such high purity of carbon dioxide can be sealed or reused directly without the gas segregation processes which have high energy consumption. In other words, with the chemical looping combustion process, not only the emission of carbon dioxide can be reduced but also the energy generating efficiency can be improved at the same time.

In the chemical looping combustion process, the metal oxides of Fe, Ni, Cu, Mn, Co, and Ge can be used as the oxygen carrier, wherein the metal oxides of Fe, Ni, and Cu are the most popular research topics. Although being popular, these oxygen carrier still have their drawbacks. The Fe oxygen carrier has high oxidation rate but low reduction rate; on the contrary, the Ni oxygen carrier has low oxidation rate but high reduction rate. Owing to the difference between both rates mentioned above, the reaction times of reduction and oxidation are disparate with each other, leading to a difficult question of how to apply the chemical looping combustion process to thermal power plant. Besides, the Cu oxygen carrier is easy to be calcined and turned into a stable status at high temperature due to the low melting point of Cu oxygen carrier. With this reason, the applications of Cu oxygen carrier are limited at high temperature.

### SUMMARY OF THE INVENTION

Therefore, in order to improve the problem described previously, a scope of the invention is to provide a Fe—Ni compound oxide for chemical looping combustion process and method of manufacturing the same.

According to an embodiment, the Fe—Ni compound oxide for chemical looping combustion process of present invention is a single-phase spinel structure. The method for manufacturing the Fe—Ni compound oxide of the invention includes the following steps: mixing Fe₂O₃ and NiO to obtain a mixing solution; ball milling the mixing solution by the solid state ball milling method; drying the mixing solution to obtain a precipitate; granulating the precipitate and then calcining the granulated precipitate to obtain the Fe—Ni compound oxide (NiFe₂O₄) with the single-phase spinel structure.

In the embodiment, the Fe—Ni compound oxide manufactured by the method of the invention is provided with high oxidation rate and high reduction rate, and capable of keeping loops and producing hydrogen gas. Therefore, the present invention can improve the problem described previously, additionally, the hydrogen gas produced by the process of present invention can be utilized to generate power or apply for other fields.

Many other advantages and features of the present invention will be further understood by the detailed description and the accompanying sheet of drawings.

### BRIEF DESCRIPTION OF THE APPENDED DRAWINGS

FIG. 1 is a flowchart illustrating a method for manufacturing a Fe—Ni compound oxide for chemical looping combustion process according to an embodiment of the invention.

FIG. 2 is an X-ray diffraction spectrograph of the Fe—Ni compound oxide manufactured in accordance with the method of FIG. 1.

FIG. 3A is a scanning electron micrograph (SEM) image demonstrating a pure NiO for chemical looping combustion process in conventional method.

FIG. 3B is a scanning electron micrograph (SEM) image demonstrating a pure NiO for chemical looping combustion process in conventional method.

FIG. 3C is a scanning electron micrograph (SEM) image demonstrating the Fe—Ni compound oxide manufactured in accordance with the method of FIG. 1.

FIG. 4 is an X-ray diffraction spectrograph illustrating the metal oxides calcined at different temperatures in the air reactor according to an embodiment of the invention.

FIG. 5 is a thermogravimetric analysis (TGA) graph illustrating the Fe—Ni compound oxide manufactured in accordance with the method of FIG. 1 under the oxidation-reduction reaction.

To facilitate understanding, identical reference numerals have been used, where possible to designate identical elements that are common to the figures.

### DETAILED DESCRIPTION OF THE INVENTION

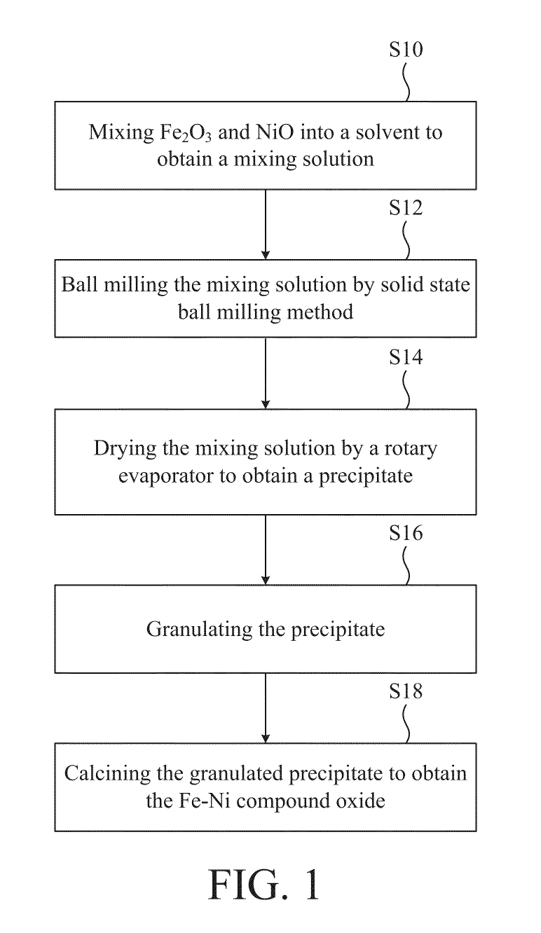

Please refer to FIG. 1. FIG. 1 is a flowchart illustrating a method for manufacturing a Fe—Ni compound oxide for chemical looping combustion process according to an embodiment of the invention.

As shown in FIG. 1, the method for manufacturing the Fe—Ni compound oxide of the invention includes the following steps: at step S10: mixing Fe₂O₃ and NiO to obtain a mixing solution; step S12: ball milling the mixing solution by the solid state ball milling method; step S14: drying the mixing solution to obtain a precipitate; step S16: granulating the precipitate, and then at step S18: calcining the granulated precipitate to obtain the Fe—Ni compound oxide.

In the embodiment, the Fe₂O₃ of step S10 can be iron oxide: powders, and similarly, the NiO can be nickel oxide powders, so that the both of them can be mixed into an alcohol solvent to obtain a mixing solution. At step S12, ball milling the mixing solution by the solid state ball milling method, the Fe₂O₃ and NiO in the mixing solution can be milled into nano-size.

At step S14, the mixing solution can be dried by a rotary evaporator in actual application, and therefore the alcohol solvent in the mixing solution would be evaporated, leaving the remaining precipitate of Fe₂O₃ and NiO. After granulating the precipitate as step S16, the granulated precipitate would be calcined to obtain the Fe—Ni compound oxide at step S18. In the embodiment, the step of calcining the granulated precipitate is performed within a temperature range from 900 to 1,200° C. and under an aerobic condition so as to provide oxygen atoms for the precipitate.

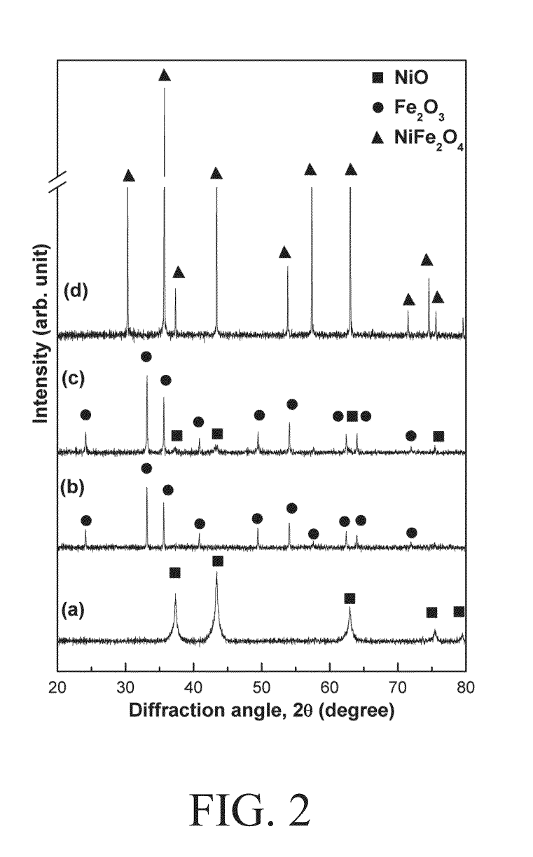

Moreover, the Fe—Ni compound oxide for chemical looping combustion process of present invention is a single-phase spinel structure (NiFe₂O₄). Please refer to FIG. 2. FIG. 2 is an X-ray diffraction spectrograph of the Fe—Ni compound oxide manufactured in accordance with the method of FIG. 1. As shown in FIG. 2, (a) is the analysis result of pure NiO; (b) is the analysis result of pure Fe₂O₃; (c) is the analysis result of mixing Fe₂O₃ and NiO in a ratio; and (d) is the analysis result of NiFe₂O₄ in the embodiment. Wherein, the FIG. 2 (d) shows that the Fe—Ni compound oxide in the embodiment is a single-phase spinel structure.

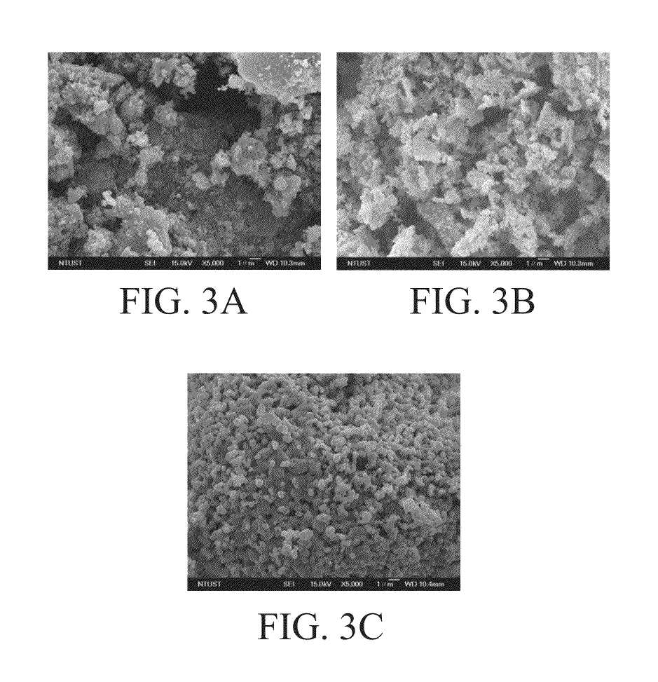

Please refer to FIGS. 3A to 3C. FIG. 3A is a scanning electron micrograph (SEM) image demonstrating a pure NiO for chemical looping combustion process in conventional method. FIG. 3B is a scanning electron micrograph (SEM) image demonstrating a pure NiO for chemical looping combustion process in conventional method. FIG. 3C is a scanning electron micrograph (SEM) image demonstrating the Fe—Ni compound oxide manufactured in accordance with the method of FIG. 1. As shown in FIGS. 3A to 3C, the Fe—Ni compound oxide manufactured in accordance with the embodiment has more uniform distribution and particle size, with this advantage, a stable rate of oxidation-reduction can be achieved while applying the Fe—Ni compound oxide to chemical looping combustion process. Wherein, the average grain diameter of the single-phase spinel structure of the Fe—Ni compound oxide manufactured in accordance with the embodiment is 200 nm.

The Fe—Ni compound oxide manufactured in accordance with the method of FIG. 1 can be utilized as oxygen carrier for providing oxygen atoms for burning fuel. In an embodiment, the Fe—Ni compound oxide with the single-phase spinel structure is placed in the fuel reactor of the chemical looping combustion process, so as to assist in combustion. After combustion, the gas emitted from burning fuel contains carbon dioxide and water vapor, wherein the water vapor can be removed by condensation. In addition, the residual gas after condensation contains up to 99% carbon dioxide, therefore, such high purity of carbon dioxide can be sealed or reused directly. During the chemical looping combustion process, a reduction reaction proceeds in the fuel reactor, converting the Fe—Ni compound oxide into metal. In actual application, in order to avoid the fuel combusting with air to generate other combustion gas, the air in the fuel reactor can be replaced with inert gas first.

In the embodiment, the fuel in the fuel reactor can be methane (CH₄), and the chemical equation of reduction reaction in the fuel reactor is as follow:

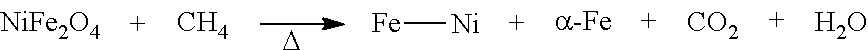

The Fe—Ni, α-Fe, gas, and thermal energy are generated after methane (CH₄) reacting with the Fe—Ni compound oxide, wherein the thermal energy is utilized for actuating the power generator, and the gas which contains carbon dioxide and water vapor is pumped out of the fuel reactor.

And then, Fe—Ni and α-Fe can be transferred into the hydrogen reactor, meanwhile, water vapor can be provided into the hydrogen reactor so as to generate hydrogen gas. Wherein, the hydrogen gas can be utilized to generate power or apply for other fields. The chemical equation in the hydrogen reactor is as follow:

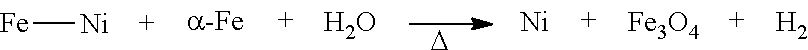

According to the chemical equation mention above, the iron atoms (Fe) are turned into Fe₃O₄ during the hydrogen production process, remaining the nickel atoms (Ni) without reaction, so it can infer that the metallic nickel (Ni) cannot produce hydrogen gas.

Wherein, Fe₃O₄ and metallic nickel (Ni) generated in the hydrogen reactor can be transferred into the air reactor to proceed an oxidation reaction, i.e., Fe₃O₄ and Ni would be calcined and converted back to the Fe—Ni compound oxide with the single-phase spinel structure at a certain temperature. The chemical equation of oxidation reaction in the air reactor is as follow:

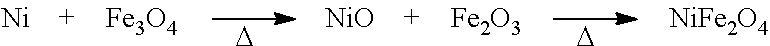

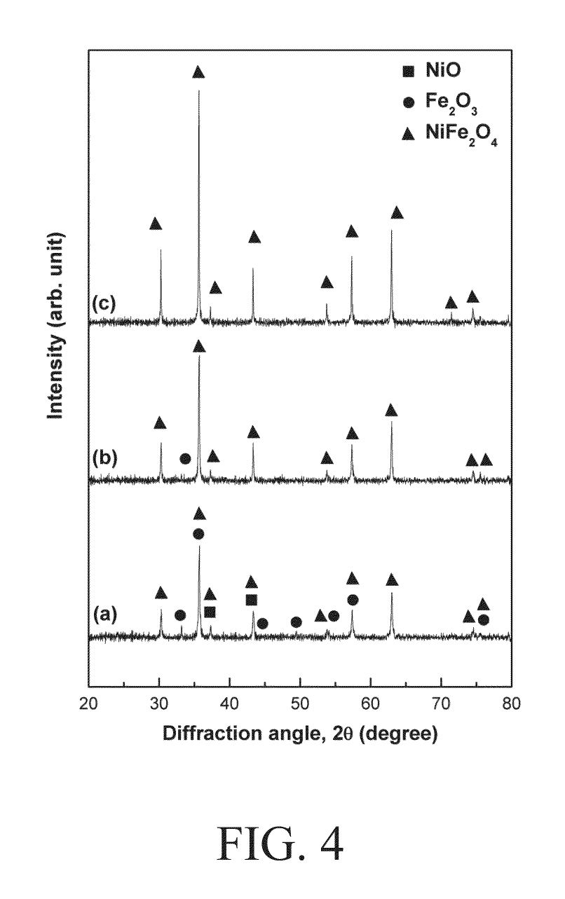

In other words, a reduction reaction proceeds in the fuel reactor, converting metal oxygen carrier into metal; after that, an oxidation reaction proceeds in the air reactor, the metal obtained above would be converted back to metal oxygen carrier; and then the reduction reaction and the oxidation reaction continue to proceed, repeating the process again and again. Please refer to FIG. 4. FIG. 4 is an X-ray diffraction spectrograph illustrating the metal oxides calcined at different temperatures in the air reactor according to an embodiment of the invention. In FIG. 4, (a) is the analysis result of calcining Fe₃O₄ and Ni at 700° C.; (b) is the analysis result of calcining Fe₃O₄ and Ni at 800° C.; and (c) is the analysis result of calcining Fe₃O₄ and Ni at 900° C. As shown in FIG. 4, when the calcined temperature exceeds 900° C., Fe₃O₄ and Ni would be converted back to the Fe—Ni compound oxide with the single-phase spinel structure.

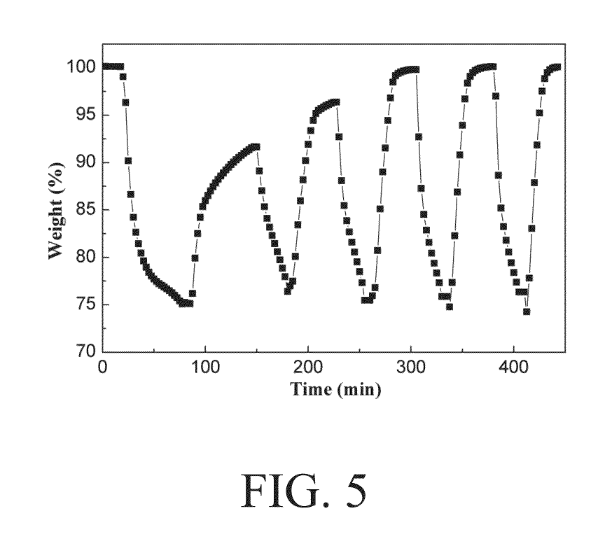

Please refer to FIG. 5. FIG. 5 is a thermogravimetric analysis (TGA) graph illustrating the Fe—Ni compound oxide manufactured in accordance with the method of FIG. 1 under the oxidation-reduction reaction. In the embodiment, methane (CH₄) can be provided to reduce the Fe—Ni compound oxide to the metal first, and then, air can be provided to oxidize the metal back to the Fe—Ni compound oxide. In FIG. 5, the horizontal axis represents the elapsed time of oxidation-reduction reaction in TGA, and the vertical axis represents the weight percent of the sample (i.e., the Fe—Ni compound oxide or the reductive metal) in TGA.

As shown in FIG. 5, each valley point of the loops indicates that the Fe—Ni compound oxide in TGA has been completely reduced to the metal, on the other hand, each peak point of the loops indicates that the metal has been completely oxidized back into the Fe—Ni compound oxide. To be noticed, the loops after 250 minutes in FIG. 5 are in the steady state and the reaction times of reduction and oxidation of the Fe—Ni compound oxide during the steady state are close, therefore, the present invention is favorable for the design of the chemical looping combustion process. Furthermore, after many loops, the reaction rate of the Fe—Ni compound oxide with the single-phase spinel structure still remains the same without obvious attenuation, so that the present invention has the capability of keeping loops.

in conclusion, compared with pure Fe₂O₃, pure NiO, and the compound of Fe₂O₃ and NiO in the prior art, the oxidation rate and reduction rate of present invention are nearly the same. Therefore, the present invention is favorable for applying the chemical looping combustion process to thermal power plant, so as to reduce the emission of carbon dioxide. Additionally, the hydrogen gas produced by the process of present invention can be utilized to generate power or apply for other fields.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for manufacturing a Fe—Ni compound oxide for chemical looping combustion process, comprising the following steps of
miring Fe2O3 and NiO into a solvent to obtain a mixing solution;
ball milling the mixing solution by solid state ball milling method;
drying the mixing solution by a rotary evaporator to obtain a precipitate;
granulating the precipitate; and
calcining the granulated precipitate to obtain the Fe—Ni compound oxide, wherein the structure of the Fe—Ni compound oxide is a single-phase spinel structure.

2. The method for manufacturing a Fe—Ni compound oxide of claim 1, wherein the step of calcining the granulated precipitate is performed under an aerobic condition.

3. The method for manufacturing a Fe—Ni compound oxide of claim 1, wherein the step of calcining the granulated precipitate is performed within a temperature range from 900 to 1,200 degree C.

4. The method for manufacturing a Fe—Ni compound oxide of claim 1, wherein the average grain diameter of the single-phase spinel structure of the Fe—Ni compound oxide is 200 nm.

5. A Fe—Ni compound oxide, used as an oxygen carrier for chemical looping combustion process, characterized in that the structure of the Fe—Ni compound oxide is a single-phase spinel structure.

6. The Fe—Ni compound oxide of claim 5, wherein the Fe—Ni compound oxide is obtained by mixing Fe2O3 and NiO into a solvent to obtain a mixing solution, ball milling the mixing solution by solid state ball milling method, drying the mixing solution by a rotary evaporator to obtain a precipitate, granulating the precipitate, and calcining the granulated precipitate.

7. The Fe—Ni compound oxide of claim 6, wherein the Fe—Ni compound oxide is obtained by calcining the granulated precipitate under an aerobic condition.

8. The Fe—Ni compound oxide of claim 6, wherein the Fe—Ni compound oxide is obtained by calcining the granulated precipitate within a temperature range from 900 to 1,200 degree C.

9. The Fe—Ni compound oxide of claim 6, wherein the average grain diameter of the single-phase spinel structure of the Fe—Ni compound oxide is 200 nm.
